(19) United States
(12) Patent Application Publication
(10) Pub. No.: US 2005/0193326 A1
(43) Pub. Date: Sep. 1, 2005

(54) Tool for configuring available functions of an application

(75) Inventors: Richard D. Dettinger, Rochester, MN (US); Shannon E. Wenzel, Colby, WI (US)

Correspondence Address: William J. McGinnis, Jr.;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/787,479

(22) Filed: Feb. 26, 2004

(51) Int. Cl. G06F 17/21; G06F 17/30

(52) U.S. Cl. 715/513

(57) ABSTRACT

Methods, systems and articles of manufacture for controlling accessibility to application functions and for configuring user interfaces to restrict access to available application functions. In one embodiment, a request is received for a web page comprising displayable content including user-selectable elements through which a user invokes one or more executable functions. The web page is provided the displayable content and then parsed to identify the user-selectable elements. At least portion of the user-selectable elements are disabled on the basis of a pre-defined transform definition to produce a re-configured web page. The re-configured web page is then returned for display.

### BACKGROUND OF THE INVENTION

1. Field of the Invention

The present invention generally relates to data processing and, more particularly, to configuring accessibility to application functions.

2. Description of the Related Art

In a web-based environment users can access applications to perform selected functions. For example, stock trading web sites may offer applications capable of determining a current stock price, submitting a stock purchase or sell request, and sending e-mail notifications of specified events (e.g., a stock reaching a given price). In a medical research environment, a web-based application may facilitate searching research databases and performing analysis on search results.

While a given web-based application may be capable of performing multiple functions, in some cases it may be desirable to limit the functions accessible by a given user. For example, in the medical research environment mentioned above users may include administrators, doctors and researchers. Each user type will have different interests with respect to the data contained in the research database. Doctors, for example, may be interested in whether a given patient's family history evidences any prostate cancer, while researches may interested in the trends of prostate cancer cases in Minneapolis over a given period of time. In each case, an application may generate interfaces that externalize the appropriate functions to perform the tasks which users desire to perform, while preventing other available functions from being externalized. If the given user is not interested in a particular function made available by an application, the function is simply disabled for that user. In this way, the user interface is simplified, by customizing interface according to the users needs. Alternatively, restricting the user's accessibility to the available functions of an application may also be desirable for security reasons.

In any case, preventing a function from being externalized may be accomplished through the use of feature flags included in the application code. For a given function, the corresponding feature flag is set to FALSE for a given user. The given function is then not externalized when the user accesses the page where the function is normally made available.

While the foregoing approach is adequate for a limited number of requests to disable a function, it becomes increasingly cumbersome as the number of requests grows. Specifically, each user interaction with the application code requires checking each of the feature flags in order to ensure that the overall user interface to is consistent.

Therefore, there is a need an improved approach to defining available functions of an application.

### SUMMARY OF THE INVENTION

The present invention generally is directed to a method, system and article of manufacture controlling accessibility to application functions and for configuring user interfaces to restrict access to available application functions.

One embodiment provides a method and program product for configuring web pages. A request is received for a web page comprising displayable content including user-selectable elements through which a user invokes one or more executable functions. The web page is provided the displayable content and then parsed to identify the user-selectable elements. At least portion of the user-selectable elements are disabled on the basis of a pre-defined transform definition to produce a re-configured web page. The re-configured web page is then returned for display.

Another embodiment provides a method and program product for defining content in user interfaces. Displayable, user-selectable elements of an electronic document are determined. Each displayable, user-selectable element is associated with a respective function available for selection by a user viewing the electronic document. The determined user-selectable elements are displayed in a document configuration interface from which a user may make at least one user selection of one of the displayable, user-selectable elements. On the basis of the at least one user selection, an interface transform component defining a user-defined version of the electronic document is generated. When a request for the electronic document is subsequently received, the interface transform component is invoked and, on the basis of the invoked interface transform component, is applied to reconfigure the electronic document to output the user-defined version of the electronic document. The user-defined version of the electronic document is then returned to the user.

Yet another embodiment provides a system for reconfiguring content displayed in user interfaces. A parser determines user-selectable elements of a web page, each user-selectable elements being configured to invoke a function. A reconfiguration interface displays a representation of the functions corresponding to the user-selectable elements determined by the parser; wherein the reconfiguration interface allows user selection of one or more of the represented functions. A transform definition generator generates a transform definition on the basis of the one or more selected functions; wherein the transform definition is configured to be invoked after the web page is produced in response to a user request and is applied to reconfigure the web page to make the one or more selected functions inaccessible.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of a data processing environment configured with a user interface configurator for defining, and applying, rules specifying which application functions to externalize to users of an application.

FIG. 2 is a representative interface screen having a plurality of buttons for invoking corresponding functions of an application.

FIG. 3 is one embodiment of a configuration interface through which a user can selectively disable accessibility to functions of an application.

FIG. 4 is an illustrative representation of the interface screen of FIG. 2 after removal of a button through which an application function is accessible.

FIG. 5 is a block diagram illustrating a sequence of events for constructing a transformation definition for an application.

FIG. 6 is a block diagram illustrating a sequence of events for applying a transformation definition to an application.

### DETAILED DESCRIPTION OF THE PREFERRED EMBODIMENTS

Introduction

The present invention generally is directed to a method, system and article of manufacture for controlling accessibility to application functions and for configuring user interfaces to restrict access to available application functions.

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

In some embodiments, the invention can be implemented in a hardware/software configuration including at least one client computer and at least one server computer. The client(s) and server(s) may be executing on a common machine or may be deployed in distributed environment in which the client(s) and server(s) communicate via a network. In a particular embodiment, aspects of the invention are implemented in a web-based environment. However, the client-server model and web-based environment are merely representative models/environments in which the present invention may be implemented, and persons skilled in the art will recognize other possibilities. Furthermore, embodiments of the present invention can apply to any comparable hardware configuration, regardless of whether the computer systems are complicated, multi-user computing apparatus, single-user workstations, or network appliances that do not have non-volatile storage of their own.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

### Embodiments

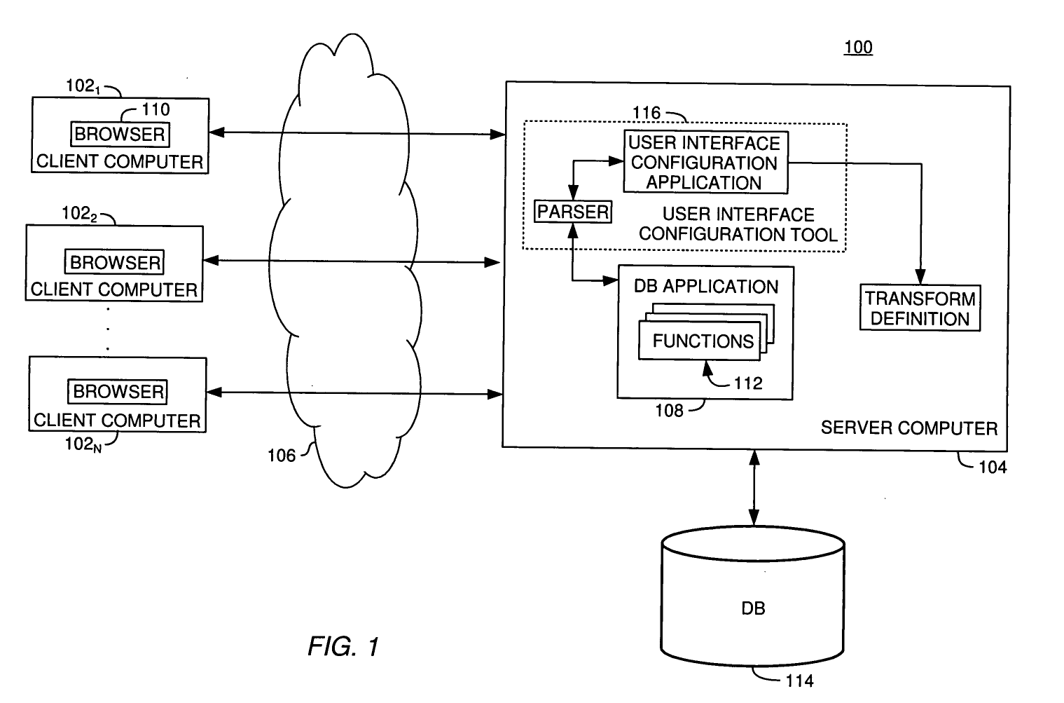

Referring now to FIG. 1, a block diagram of one embodiment of a data processing system 100 is illustrated. Illustratively, the data processing system 100 is a networked environment in which a plurality of client computers 102₁, 102₂ . . . 102_{N} access a server computer 104 via a network 106. In one embodiment, the network 106 is the Internet and the server computer 104 is a web-based server hosting an application 108. Accordingly, the client computers 102 may each be configured with a browser application 110 capable of navigating to the network address of the server computer 104 and submitting user requests to the application 108. In particular, users may invoke one or more functions 112 implemented by the application 108. In the illustrative embodiment, the application 108 is a database application capable of performing functions with respect to data stored in a database 114. However, it is understood that the application 108 may be any application configured to execute user selected functions 112. It is also understood that the data processing system 100 need not be a web-based environment and that aspects of the invention are described with respect to such an environment for purposes of illustration only.

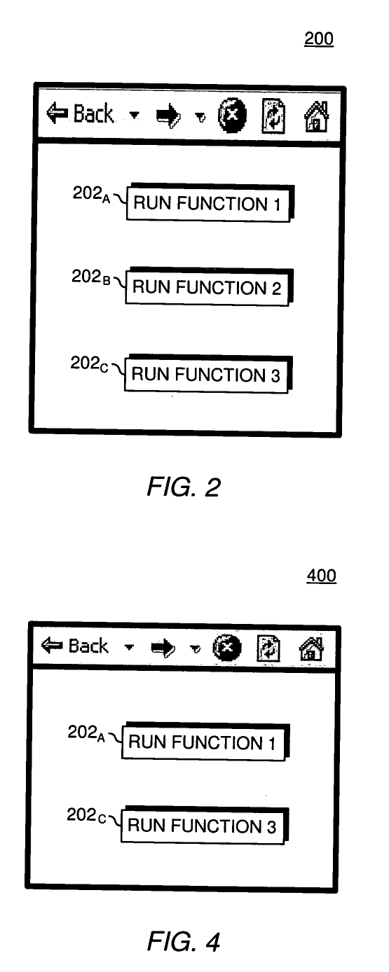

A user accessing the database application 108 via the browser 110 is presented with an interface screen 200 (e.g., a web page), such as the one shown in FIG. 2. The interface screen 200 shows three functions externalized by the application 108. Illustratively, the functions are externalized in the form of buttons 202A-C of a graphical user interface. A user desiring to execute a given function simply clicks on the respective button. For example, clicking on a first button 202A causes the application 108 to implement a first function. It is noted that the buttons 202A-C are merely illustrative and that the functions may be externalized through other graphical elements such as, for example, drop-down menus and hyperlinks. It is also noted that the interface screen 200 is merely representative and that the application 108 may generate other interface screens externalizing other functions.

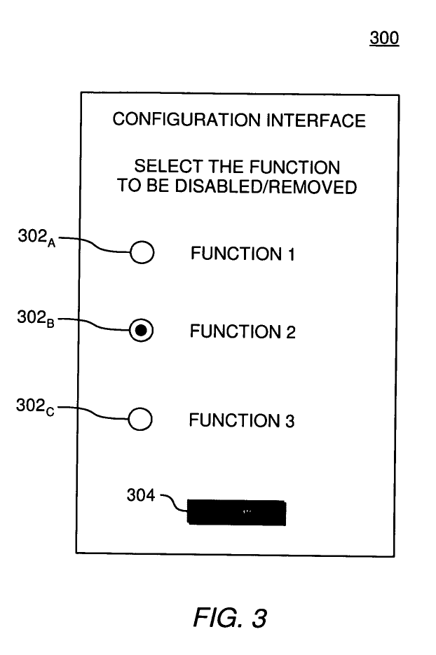

In some cases, it may be desirable to prevent one or more functions on a given screen from being externalized. To this end, a user interface configuration tool 116 is provided, as shown in FIG. 1. In general, the configuration tool 116 allows the user to select which functions 112 of the application 108 will be externalized. In one embodiment, the configuration tool 116 generates a configuration interface displaying a representation of each of the user-selectable functions 112 of the application 108. One such configuration interface 300 is illustrated FIG. 3. The configuration interface 300 includes a checkbox for each of functions of the application 108. In this case, three checkboxes 302A-C are shown and may be considered to correspond to those functions externalized by the buttons 202A-C shown in FIG. 2. A user then selects those checkboxes corresponding to functions to be disabled. The selections are returned to the configuration tool 116 by clicking a submit button 304.

It should be noted that the configuration interface 300 is merely representative of one embodiment. In another embodiment, the layout of the configuration interface 300 may be substantially the same as that of the screens of the application 108. For example, the configuration tool 116 may present the user with a screen resembling the interface screen 200 shown in FIG. 2. Functions represented on the screen may then be disabled by positioning a mouse pointer over the corresponding button (e.g., the buttons 202A-C) and right-clicking the mouse. This approach may be more intuitive for some users.

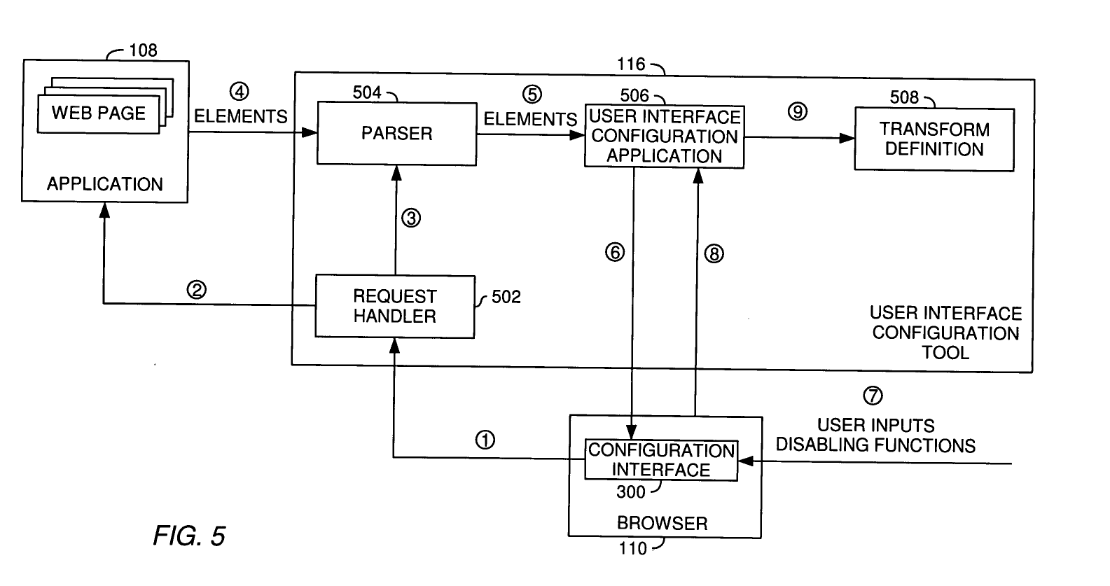

After submitting selected functions to disable, the previously disabled functions will no longer be available when the user next invokes the application 108. The manner in which functions are made unavailable may vary according to implementation. For example, in one embodiment, the graphical elements through which corresponding functions are invoked may be removed from the user interface, or otherwise disabled. One example of this embodiment is shown with respect FIG. 4. In particular, FIG. 4 shows an interface screen 400 corresponding to the interface screen 200 after “Function 2” has been made unavailable to the user. Accordingly, the corresponding button 202B is not shown. Alternatively, the button 202B may be grayed-out. In this context it should be clear that while the graphical elements externalizing the functions are truly disabled (rendered inoperable or removed from the interface), “disabling” a function refers to making the function unavailable, rather than affecting the underlying application code to make the function incapable of executing. Thus, in one aspect, the present invention allows functions to be disabled without setting values of variables (e.g., a feature flags) within the application code. This aspect will be further described below with respect FIG. 5.

FIG. 5 shows one sequence of steps that may be implemented to disable functions of an application, e.g., the application 108. For purposes of illustration, the application 108 will be assumed to be a web-based application that returns web pages for display in the browser user interface. The web page may be an HTML document or an XML document, which in either case may be a static document or a generated document (i.e., generated by the application 108). The sequence of steps is represented by circled numerals 1-8. It is contemplated that the user operating the browser 110 may first invoke the configuration tool 116 and then issue an explicit request to disable functions of the application 108. This may involve, for example, providing the configuration tool 116 with a network address of the application 108. Illustratively, the request to disable functions is received and handled by a request handler 502 of the configuration tool 116. The request handler 502 then accesses the application 108 and invokes a parser 504. The parser 504 parses the web page to identify the function selection elements contained in the page. The function selection elements may be any user-selectable elements (e.g., the buttons 202 shown in FIG. 2) through which the corresponding function (e.g., one of the functions 112 shown in FIG. 1) is invoked. Identification of the user-selectable elements is facilitated where the web page is an XML document, given the grammatical rigidity of such documents. XML documents are highly structured making its constituent components, such as user-selectable elements, readily identifiable to the parser. However, in some cases the web page may not be a well-defined document, as in the case of an HTML document where rules of grammar are relaxed. In this case, it is contemplated that the HTML document may first be transformed into an XML document and then parsed. Alternatively, assuming the HTML document is sufficiently well-defined, the parser 504 may be configured to identify the beginning and ending tags delimiting the definitions of user-selectable elements. Persons skilled in the art will recognize that the parser 504 may be configured to handle other document types. In any case, it should be noted that the parser 504 is dynamically adaptable even to non-existing applications, since the parser 504 is not constructed to identify specific types of user-selectable elements of certain application types, but rather to identify where user-selectable elements are defined within a document, regardless of the type of application.

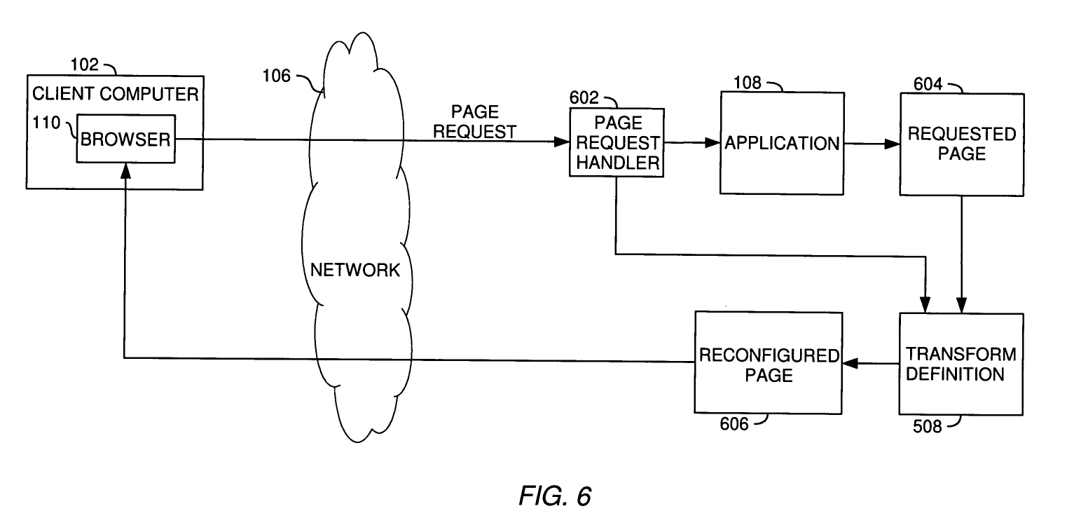

The user-selectable elements identified by the parser 504 are then input to a user interface configuration application 506. The user interface configuration application 506 outputs an appropriate configuration interface (such as the configuration interface 300 described above with respect FIG. 3) which includes a representation of all the user-selectable elements identified by the parser 504. The user may then disable one or more of the functions in the manner described above with reference to FIGS. 3 and 4. The user's selections are returned to the user interface configuration application 506, which then generates a transform definition 508. In a particular embodiment, the transform definition 508 is an XSL transform definition. In this case, user interface configuration application 506 includes an XSL transform engine which takes as input a page definition and applies the transform definition 508 to the page definition to output a revise page. More generally, however, the transform definition 508 is any construct that is built on the basis of the user's selections and applied to externalize only those application functions selected by the user. As such, it is contemplated that the transform definition 508 may be specific to a particular user and application. However, other variations are also contemplated. For example, a system administrator may create a transform definition applicable to multiple users for a given application. In any case, once created, the transform definition 508 may be stored as a persistent object and subsequently retrieved when a user, for whom the transform definition is defined, accesses the corresponding application. One embodiment of the application of a transform definition in this context is described with respect FIG. 6.

FIG. 6 illustrates one embodiment of what may be considered the runtime application of a transform definition in the data processing environment 100 of FIG. 1. In particular, the user operating the browser 110 on a client computer 102 establishes a network connection over the network 106 and issues page requests to an application 108 for which a transform definition 508 exists. The requests may be received and handled by a page request handler 602. In addition to forwarding the request to the application 108, the page request handler 602 is also configured to invoke any transform definition defined for the application 108, in this case the transform definition 508. In response to a request, the application 108 generates/retrieves the requested page 604. Before returning the page 604 to the browser 110, the transform definition 508 is applied to the requested page 604. As a result, a reconfigured page 606 is produced. The reconfigured page 606 externalizes only those application functions specified by a user and defined by the transform definition 508. An example of the requested page and corresponding reconfigured page is described above with respect to FIGS. 3 and 4. The reconfigured page 606 is then returned to the user for display in the browser interface. In this way only selected functions of the application 108 are accessible to the user while avoiding any changes to the application itself. Thus, the application can be customized for any user/environment without requiring developers to re-code portions of the application to produce different instances/versions of the application.

While the foregoing is directed to embodiments of the present invention, other and further embodiments of the invention may be devised without departing from the basic scope thereof, and the scope thereof is determined by the claims that follow.

1. A method for configuring web pages, comprising:
receiving a request for a web page comprising displayable content including user-selectable elements through which a user invokes one or more executable functions;
providing the web page with the displayable content;
parsing the web page to identify the user-selectable elements;
disabling at least portion of the user-selectable elements on the basis of a pre-defined transform definition to produce a re-configured web page; and then
returning the re-configured web page for display.

2. The method of claim 1, wherein disabling comprises making the one or more executable functions corresponding to the portion of the user-selectable elements inaccessible to the user viewing the re-configured web page.

3. The method of claim 1, wherein disabling comprises removing the portion of the user-selectable elements from the web page prior to returning the re-configured web page.

4. The method of claim 1, wherein the pre-defined transform definition is an XSL transform defined for the web page and specifying the portion of the user-selectable elements to be disabled.

5. The method of claim 1, wherein the user-selectable elements are graphical user interface elements.

6. The method of claim 1, wherein the request is issued by a web browser.

7. A method for defining content in user interfaces, comprising:
determining displayable, user-selectable elements of an electronic document, each displayable, user-selectable element being associated with a respective function available for selection by a user viewing the electronic document;
displaying the determined user-selectable elements in a document configuration interface;
receiving, from the document configuration interface, at least one user selection of one of the displayable, user-selectable elements;
on the basis of the at least one user selection, generating an interface transform component defining a user-defined version of the electronic document;
in response to a request from a user for the electronic document:
providing the electronic document;
invoking the interface transform component;
on the basis of the invoked interface transform component, reconfiguring the provided electronic document to output the user-defined version of the electronic document; and
returning the user-defined version of the electronic document to the user.

8. The method of claim 7, wherein the user request is issued by a web browser

9. The method of claim 7, wherein the electronic document is a web page.

10. The method of claim 7, wherein the displayable, user-selectable elements comprise buttons, which when clicked by the user invoke the respective function.

11. A computer readable medium containing a program which, when executed, performs an operation for configuring web pages, the operation comprising:
receiving a request for a web page comprising displayable content including user-selectable elements through which a user invokes one or more executable functions;
providing the web page with the displayable content;
parsing the web page to identify the user-selectable elements;
disabling at least portion of the user-selectable elements on the basis of a pre-defined transform definition to produce a re-configured web page; and then
returning the re-configured web page for display.

12. The computer readable medium of claim 11, wherein disabling comprises making the one or more executable functions corresponding to the portion of the user-selectable elements inaccessible to the user viewing the re-configured web page.

13. The computer readable medium of claim 11, wherein disabling comprises removing the portion of the user-selectable elements from the web page prior to returning the re-configured web page.

14. The computer readable medium of claim 11, wherein the pre-defined transform definition is an XSL transform defined for the web page and specifying the portion of the user-selectable elements to be disabled.

15. The computer readable medium of claim 11, wherein the user-selectable elements are graphical user interface elements.

16. A computer readable medium containing a program which, when executed, performs an operation for defining content in user interfaces, the operation comprising:
determining displayable, user-selectable elements of an electronic document, each displayable, user-selectable element being associated with a respective function available for selection by a user viewing the electronic document;
displaying the determined user-selectable elements in a document configuration interface;
receiving, from the document configuration interface, at least one user selection of one of the displayable, user-selectable elements;
on the basis of the at least one user selection, generating an interface transform component defining a user-defined version of the electronic document;
in response to a request from a user for the electronic document:
providing the electronic document;
invoking the interface transform component;
on the basis of the invoked interface transform component, reconfiguring the provided electronic document to output the user-defined version of the electronic document; and
returning the user-defined version of the electronic document to the user.

17. The computer readable medium of claim 16, wherein the user request is issued by a web browser.

18. The computer readable medium of claim 16, wherein the electronic document is a web page.

19. The computer readable medium of claim 16, wherein the displayable, user-selectable elements comprise buttons, which when clicked by the user, invoke the respective function.

20. A system for reconfiguring content displayed in user interfaces, comprising:
a parser for determining user-selectable elements of a web page, each user-selectable elements being configured to invoke a function;
a reconfiguration interface for displaying a representation of the functions corresponding to the user-selectable elements determined by the parser; wherein the reconfiguration interface allows user selection of one or more of the represented functions; and
a transform definition generator for generating a transform definition on the basis of the one or more selected functions; wherein the transform definition is configured to be invoked after the web page is produced in response to a user request and is applied to reconfigure the web page to make the one or more selected functions inaccessible.

21. The system of claim 20, wherein the transform definition is an XSL transform.

22. The system of claim 20, wherein the transform definition is applied to make the one or more selected functions inaccessible by removing the corresponding user-selectable elements.

23. The system of claim 20, wherein the representation of the functions is the user-selectable elements.
